(19) United States
(12) Patent Application Publication
(10) Pub. No.: US 2011/0290671 A1
(43) Pub. Date: Dec. 1, 2011

(54) ELECTROCHEMICAL GAS SENSOR

(75) Inventors: Frank METT, Lubeck (DE); Sabrina SOMMER, Lubeck (DE); Kerstin LICHTENFELDT, Timmendorfer Strand (DE)

(73) Assignee: Drager Safety AG & Co. KGaA, Lubeck (DE)

(21) Appl. No.: 13/040,890

(22) Filed: Mar. 4, 2011

(30) Foreign Application Priority Data
May 28, 2010 (DE) DE 102010021975.4

(51) Int. Cl. G01N 27/30; B82Y 99/00

(52) U.S. Cl. 205/780.5; 204/431; 204/412; 205/794.5; 977/750; 977/752

(57) ABSTRACT

An electrochemical gas sensor for detecting hydrocyanic acid in a gas sample has a measuring electrode (3) formed of carbon nanotubes (CNT) and a counterelectrode (8) in an electrolyte (9), which contains lithium bromide in an aqueous solution.

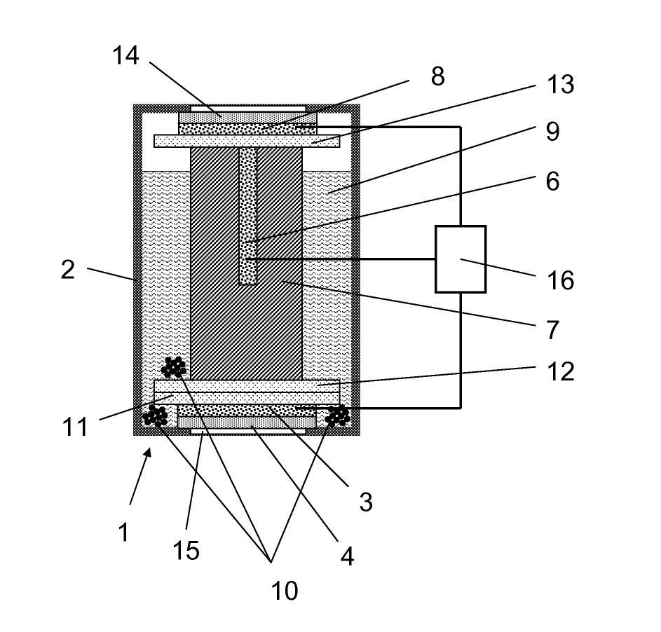

### CROSS REFERENCE TO RELATED APPLICATIONS

This application claims the benefit of priority under 35 U.S.C. §119 of German Patent Application DE 10 2010 021 975.4 filed May 28, 2010, the entire contents of which are incorporated herein by reference.

### FIELD OF THE INVENTION

The present invention pertains to an electrochemical gas sensor for detecting hydrocyanic acid.

### BACKGROUND OF THE INVENTION

A gas sensor for determining SO₂ or H₂S, which contains a measuring electrode, which has carbon nanotubes, is known from DE 10 2006 014 713 B3. The electrolyte contains a mediator compound based on transition metal salts, with which selective determination of the desired gas component is possible.

The mediator compounds are compounds that contain at least one more group, selected from among hydroxyl and acid groups, besides at least one acid group. The mediator compound is especially a carboxylic acid salt, having at least one hydroxyl group, preferably at least two hydroxyl groups, and/or at least one more carboxylic acid group, besides the one carboxylic acid group. Tetraborates, such as sodium tetraborate or lithium tetraborate, are also suitable compounds. Transition metal salts, especially Cu salts of such mediators, make possible the selective determination of SO₂.

A measuring device described in US 2005/0230 270 A1 contains a microelectrode array consisting of carbon nanotubes to detect substances in liquid or gaseous samples.

An electrochemical gas sensor, whose measuring electrode consists of diamond-like carbon, is known from DE 199 39 011 C1. Aqueous lithium bromide, which also acts as a mediator, is used as the electrolyte. The mediator function is based on the oxidation of the lithium bromide into bromine by the chlorine gas to be measured. The potential at the measuring electrode is set such that bromine is reduced at the measuring electrode.

### SUMMARY OF THE INVENTION

The basic object of the present invention is to propose a gas sensor and a method for detecting hydrocyanic acid.

According to the invention, an electrochemical gas sensor is provided for detecting hydrocyanic acid in a gas sample. The electrochemical gas sensor comprises a measuring electrode containing carbon nanotubes, an electrolyte solution which contains lithium bromide and a counterelectrode. The measuring electrode and the counterelectrode are in contact with the electrolyte solution.

According to another aspect of the invention, a method of electrochemical gas sensing is provided. The method comprises the steps of providing an electrochemical gas sensor comprising a measuring electrode comprising carbon nanotubes, an electrolyte solution which contains lithium bromide and a counterelectrode. The measuring electrode and the counterelectrode are in contact with the electrolyte solution. A potential on the measuring electrode is set such that dissolved bromine is present in the electrolyte for a detection reaction. The method may further comprise detecting hydrocyanic acid with an electrochemical gas sensor.

It was surprisingly found that hydrocyanic acid can be detected at a high sensitivity with a measuring electrode consisting of carbon nanotubes (CNT) combined with an aqueous electrolyte, which contains lithium bromide, and changes in temperature and humidity have only a minor effect on the measured signal. Even though it has already been known that an electrode consisting of diamond-like carbon can be used combined with an aqueous electrolyte consisting of lithium bromide, it was surprisingly found that hydrocyanic acid can be detected only in combination with a measuring electrode consisting of carbon nanotubes (CNT). The potential at the measuring electrode must be set for the detection reaction such that bromine is present, freely dissolved, in the electrolyte due to the oxidation of the lithium bromide. The working point is to be set now such that the lowest possible sensor basic current is present.

Measuring electrodes manufactured from carbon nanotubes (CNT) are stable over a long time and can be integrated in existing sensor constructions in a simple manner. Carbon nanotubes are structurally related to the fullerenes, which can be prepared, e.g., by evaporating carbon according to a laser evaporation method. A single-walled carbon nanotube has, for example, a diameter of one nanometer and a length of about a thousand nanometers. Besides single-walled carbon nanotubes, double-walled carbon nanotubes (DW CNT) and structures with multiple walls (MW CNT) are known as well.

The layer thickness of the electrode material in the finished electrode is in a range of 0.5 μm to 500 μm and preferably 10 μm to 50 μm in measuring electrodes consisting of carbon nanotubes (CNT).

Multiwalled carbon nanotubes (MW CNT), in particular, yield an especially high measured signal and represent an especially preferred embodiment.

Carbon nanotubes are provided due to the manufacture with metal atoms, e.g., Fe, Ni, Co, including the oxides thereof, so that such carbon nanotubes on measuring electrodes have catalytic activities. It proved to be advantageous to remove these metal particles by acid treatment.

The carbon nanotubes are advantageously applied to a porous carrier, a nonwoven material or a diffusion membrane. The carbon nanotubes are fitted together in self-aggregation or by means of a binder. PTFE powder is preferably used as the binder.

It is especially advantageous to prepare the carbon nanotubes from a prefabricated film, a so-called “buckypaper.” The measuring electrode can then be punched directly out of the buckypaper. Large quantities can thus be manufactured in a cost-effective manner.

The measuring cell has openings, which are provided with a membrane permeable to the analyte and otherwise seal the measuring cell towards the outside. The electrochemical cell contains at least one measuring electrode and a counterelectrode, which may be arranged coplanarly, plane-parallel or radially in relation to one another and are each flat. In addition to the counterelectrode, a reference electrode may be present as well. A separator, which maintains the electrodes at spaced locations from one another and is impregnated with the electrolyte, is located between the plane-parallel electrodes.

Precious metals, such as platinum or iridium, carbon nanotubes or an electrode of a second type, which consists of a metal, which is at equilibrium with a poorly soluble metal salt, may be used as electrode materials in the reference electrode.

The counterelectrode preferably consists of a precious metal, e.g., gold, platinum, iridium or carbon nanotubes.

Alkali or alkaline earth halides, which are preferably hygroscopic in aqueous solution, preferably bromides, are used as supporting electrolytes. The pH value of the electrolyte is preferably stabilized with a buffer. Especially advantageous formulas are an aqueous LiBr solution or an aqueous LiBr solution with saturated CaCO₃ as a solid solute. Calcium carbonate is used as a pH stabilized for the electrolyte solution. Other alkaline earth carbonates, such as magnesium carbonate or barium carbonate, which are expressly covered by the scope of protection, are also suitable for use as pH stabilizers as an alternative.

An advantageous use of an electrochemical gas sensor, which has a measuring electrode consisting of carbon nanotubes (CNT) and a counterelectrode in an electrolyte, which contains lithium bromide, is in the detection of hydrocyanic acid in a gas sample. Multiwalled carbon nanotubes (MW CNT) represent a preferred material for the measuring electrode. Especially preferred electrolytes are an aqueous LiBr solution or an aqueous LiBr solution with saturated CaCO₃ as a solid solute.

A method according to the present invention for detecting hydrocyanic acid with an electrochemical gas sensor, which has a measuring electrode consisting of carbon nanotubes (CNT) and an aqueous LiBr solution as an electrolyte, consists of setting the potential at the measuring electrode such that dissolved bromine is present in the electrolyte for the detection reaction.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

The only FIGURE is a schematic sectional view of a gas sensor according to the invention.

### DESCRIPTION OF THE PREFERRED EMBODIMENTS

Referring to the drawings in particular, the only figure shows a gas sensor 1, in which a measuring electrode 3 consisting of carbon nanotubes (CNT) on a diffusion membrane 4, a reference electrode 6 in a wick 7 and a counterelectrode 8 are arranged in a sensor housing 2. The interior of the sensor housing 2 is filled with an electrolyte 9 consisting of an aqueous LiBr solution, and a pH stabilizer consisting of calcium carbonate as a solid solute 10 is additionally present as well. The electrodes 4, 6, 8 are maintained at a fixed distance from each other by means of liquid-permeable nonwovens 11, 12, 13. The gas enters through an opening 15 in the sensor housing 2. The gas sensor 1 is connected in the known manner to a potentiostat 16, with which the potential on the measuring electrode 3 as well as the working point for the sensor basic current are set.

While specific embodiments of the invention have been described in detail to illustrate the application of the principles of the invention, it will be understood that the invention may be embodied otherwise without departing from such principles.

### APPENDIX

### List of Reference Numbers

1 Gas sensor
2 Sensor housing
3 Measuring electrode
4 Diffusion membrane
6 Reference electrode
7 Wick
8 Counterelectrode
9 Electrolyte
10 Solid solute
11, 12, 13 Nonwoven
15 Opening
16 Potentiostat

What is claimed is:

1. An electrochemical gas sensor for detecting hydrocyanic acid in a gas sample, the electrochemical gas sensor comprising:
a measuring electrode containing carbon nanotubes;
an electrolyte solution which contains lithium bromide; and
a counterelectrode, the measuring electrode and the counterelectrode being in contact with said electrolyte solution.

2. An electrochemical gas sensor in accordance with claim 1, wherein the carbon nanotubes are located on a porous carrier, a nonwoven material or a diffusion membrane.

3. An electrochemical gas sensor in accordance with claim 1, wherein the carbon nanotubes are fitted together by self-aggregation or by means of a binder.

4. An electrochemical gas sensor in accordance with claim 3, wherein the binder is PTFE.

5. An electrochemical gas sensor in accordance with claim 1, wherein the carbon nanotubes are present as a film in the form of a so-called buckypaper.

6. An electrochemical gas sensor in accordance with claim 1, wherein the carbon nanotubes are present in the form of single-walled or multiwalled carbon nanotubes (MW CNT) with a layer thickness of the finished electrode material ranging from 0.5 μm to 500 μm.

7. An electrochemical gas sensor in accordance with claim 1, wherein the counterelectrode consists of a precious metal, iridium or carbon nanotubes.

8. An electrochemical gas sensor in accordance with claim 1, further comprising a reference electrode, which consists of at least one of a precious metal, carbon nanotubes or an electrode of a second type, wherein said electrode of the second type is a metal, which is at equilibrium with a poorly soluble metal salt.

9. An electrochemical gas sensor in accordance with claim 1, wherein the electrolyte is present as an aqueous electrolyte.

10. An electrochemical gas sensor in accordance with claim 1, wherein the electrolyte is an aqueous LiBr solution or an aqueous LiBr solution with saturated CaCO₃ as a solid solute.

11. An electrochemical gas sensor in accordance with claim 1, wherein the carbon nanotubes are present in the form of single-walled or multiwalled carbon nanotubes (MW CNT) with a layer thickness of a finished electrode material ranging from 10 μm to 50 μm.

12. An electrochemical gas sensor in accordance with claim 1, wherein the counterelectrode consists of one or more of gold, platinum, iridium and carbon nanotubes.

13. A method of electrochemical gas sensing, the method comprising the steps of:
providing an electrochemical gas sensor comprising a measuring electrode comprising carbon nanotubes (CNT), an electrolyte solution which contains lithium bromide and a counterelectrode, the measuring electrode and the counterelectrode being in contact with the electrolyte solution; and
setting a potential on the measuring electrode such that dissolved bromine is present in the electrolyte for a detection reaction.

14. A method of electrochemical gas sensing according to claim 13, further comprising:
detecting hydrocyanic acid with an electrochemical gas sensor.

15. A method of electrochemical gas sensing according to claim 14, wherein the carbon nanotubes are present as multiwalled carbon nanotubes (MW CNT).

16. A method of electrochemical gas sensing according to claim 14, wherein the electrolyte solution is an aqueous LiBr solution or an aqueous LiBr solution with saturated CaCO₃ as a solid solute.

17. A method of electrochemical gas sensing according to claim 14, wherein the carbon nanotubes are located on a porous carrier, a nonwoven material or a diffusion membrane.

18. A method of electrochemical gas sensing according to claim 14, wherein the carbon nanotubes are fitted together by self-aggregation or by means of a binder.

19. A method of electrochemical gas sensing according to claim 18, wherein the binder is PTFE.

20. A method of electrochemical gas sensing according to claim 14, wherein the carbon nanotubes are present as a film in the form of a so-called buckypaper.
